(19) United States
(12) Patent Application Publication
(10) Pub. No.: US 2001/0014274 A1
(43) Pub. Date: Aug. 16, 2001

(54) Truck towing apparatus

(76) Inventor: Joseph Whaley, Doniphan, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 09/790,825

(22) Filed: Feb. 22, 2001

Related U.S. Application Data
(63) Continuation-in-part of application No. 09/503,808, filed on Feb. 15, 2000.

(51) Int. Cl. B60P 3/12

(52) U.S. Cl. 414/563

(57) ABSTRACT

Truck towing apparatus connecting a tow truck to a truck to be towed. End pieces are attached to fifth wheels of the respective trucks. End booms are attached to the respective end pieces. Each end boom has a proximal end attached to its associated end piece and a distal end extending in the direction of the other truck. The distal ends of the end boom are attached to a connecting boom. A straddle bar attaches to a rear end of the truck to be towed and straddles the connecting boom. The rear end of the truck to be towed is raised off the ground to facilitate towing by the towing truck, and the straddle bar is secured to the rear end of the truck to be towed, after it is raised, to maintain the rear end of the truck to be towed in its elevated position.

### CROSS-REFERENCE TO RELATED APPLICATIONS

This is a Continuation-In-Part of application Ser. No. 09/503,808 filed Feb. 15, 2000.

### STATEMENT REGARDING FEDERALLY SPONSORED RESEARCH OR DEVELOPMENT

Not applicable.

### BACKGROUND OF THE INVENTION

This invention relates to vehicle hauling, and more particularly, to a towing apparatus attachable to a truck used to transport or tow other trucks from one location to another.

It is often necessary to haul trucks of various types, for example, tractor vehicles. Sometimes the truck is hauled from one truck dealership to another, or from a central receiving site to a remote dealership. At other times when a vehicle breaks down, it is necessary to haul the vehicle from wherever it became disabled to a repair facility.

It is known to use a towing apparatus to accomplish such transport, and examples of prior towing systems are disclosed in these patents, as well as other towing systems known in the art have a number of drawbacks.

First, these prior systems are very expensive, costing many thousands of dollars. Second, they can be cumbersome to install and use. One reason for this is the number of components which must be assembled together in order to attach the two vehicles together. An incorrect assembly or connection between the towing and towed vehicles not only puts the vehicles at risk, but also the driver of the towing vehicle as well as occupants of other vehicles in the vicinity of the two trucks if something goes wrong.

### BRIEF SUMMARY OF THE INVENTION

Among the several objects of the present invention may be noted the provision of a truck transport apparatus for use in towing a vehicle such as tractor vehicle. The transport of the present invention is advantageous in being readily installed on the vehicle. Connections between the towing vehicle and towed vehicle are also readily made. Installation of the apparatus and attachment of the towed and towing vehicles can be done by one person, quickly, and without the need of special tools. Once the vehicles are attached together, transport of the towed vehicle to its destination is accomplished safely and there is no danger of the towed vehicle becoming disconnected from the towing vehicle. The connection between vehicles is such that the towed vehicle is very stable and will not sway as it turns through corners. At the destination site, the towed vehicle can be quickly disconnected from the towing vehicle. Thereafter, the boom apparatus is easily removed and stored. Advantageously, the apparatus of the present invention requires few parts, can be fabricated from readily obtainable structural steel or similar material, and can be fabricated so as to cost substantially less than other truck transport systems.

In accordance with the invention, generally stated, a transport boom apparatus of the present invention includes first and second end pieces each of which is attachable to the fifth wheel of either a towing truck or a towed truck. An end boom is securably attached to each end piece, each end boom extending rearwardly of the vehicle to which it is connected toward the other vehicle. A connection boom has one end attachable to the distal end of one end boom, and its other end attachable to the distal end of the other end boom. A straddle bar straddles the connection boom adjacent its end near the towed truck. The rear end of the towed vehicle is raised and a chain, for example, is used to attach the frame of the towed vehicle to the straddle bar to maintain this end of the towed vehicle in its elevated position. The resulting assembly securely connects the two vehicles together so the one vehicle can safely tow the other. Other objects and features will be in part apparent and in part pointed out hereinafter.

### BRIEF DESCRIPTION OF THE SEVERAL VIEWS OF THE DRAWINGS

In the drawings,

FIG. 1 is an elevational view of a first embodiment of the tow boom apparatus in use;

FIG. 2 is an elevational view of a second embodiment of the apparatus also in use;

FIG. 3. Is a perspective view of the apparatus, partially exploded;

FIGS. 4A and 4B are respective side and end elevational views of one end piece of the apparatus;

FIGS. 5A and 5B are respective side and end elevational views of the other end piece;

FIGS. 6A and 6B are respective side and end elevational views of one of the end booms;

FIGS. 7A and 7B are respective side and end elevational views of the connecting boom;

FIGS. 8A, 8B, and 8C are respective perspective, side elevational and end elevational views of the one straddle bar used with the apparatus; and,

FIGS. 9A and 9B are respective top plan and side elevational views of a second straddle bar used with the apparatus.

Corresponding reference characters indicate corresponding parts throughout the drawings.

### DETAILED DESCRIPTION OF THE INVENTION

### Description of the Components

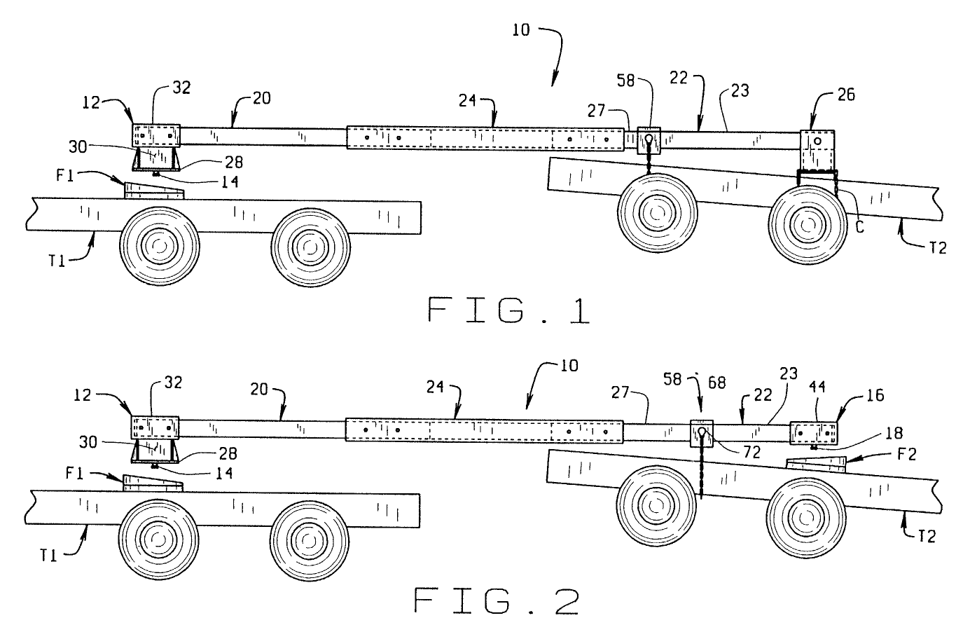

Referring now to FIG. 1 and FIG. 2, the present invention is a truck towing apparatus 10. The truck towing apparatus 10 includes a first end piece 12 having a kingpin 14. A first end boom 20 has a proximal end 21 attached to the first end piece 12. A second end boom 22 also has a proximal end 23 attached to the second end piece 16. A distal end 25 of the first end boom 20 and a distal end 27 of the second end boom 22 are inserted into, and connected to, a connecting boom 24.

FIG. 1 shows the truck towing apparatus 10 configured to tow a truck T2 when the truck to be towed does not have its own fifth wheel. In that configuration, a chain is used to attached a straddle bar 26 to the chassis of the truck to be towed. Cross member 58 is then attached by another chain to the elevated rear frame of the truck to be towed.

FIG. 2 shows the truck towing apparatus 10 configured to tow a truck T2 when the truck to be towed has its own fifth wheel. In that configuration, a second end piece 16 is engaged to the fifth wheel of the truck to be towed. A chain is then used to attach the cross member 58 to the elevated end of the truck to be towed.

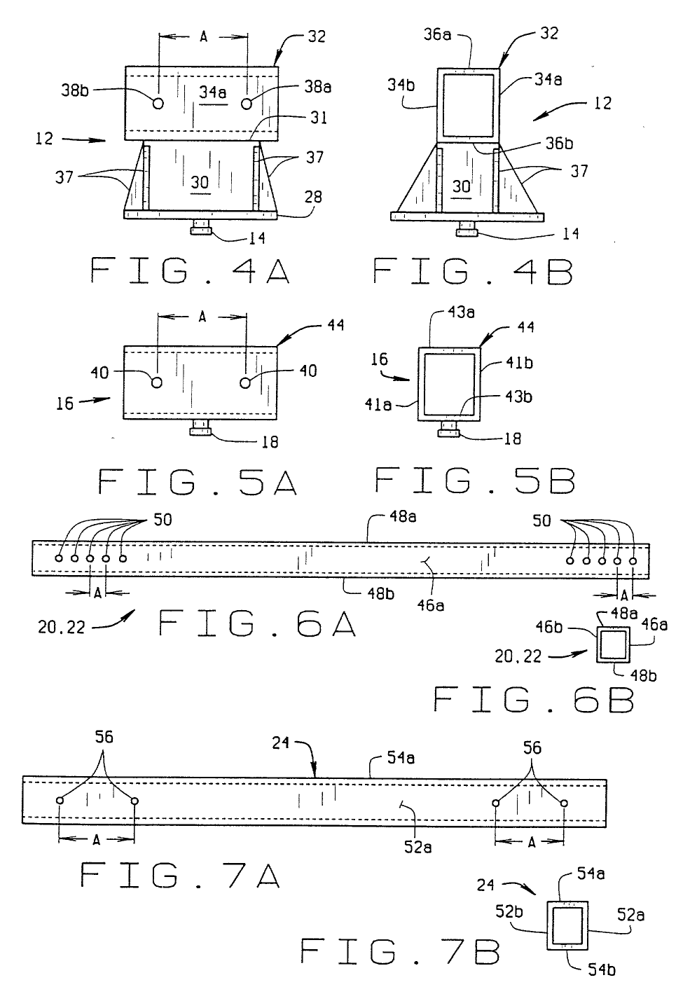

A first end piece 12 shown in FIG. 4A and FIG. 4B includes a first kingpin plate 28 depending from the underside of the end piece 12, and from which the kingpin 14 extends. Four vertical plates 30 are welded or otherwise secured to a top surface 31 of first kingpin plate 28, and extend vertically above the first kingpin plate. A collar 32 is welded or otherwise attached to edges 33 of the vertical plates 30. Collar 32 is rectangular in cross-section and is formed by a first vertical side plate 34a, a second vertical side plate 34b, an upper cap piece 36a, and a lower cap piece 36b, all of which are welded or otherwise connected to from the rectangular cross-section. Alternatively, collar 32 may be manufactured from a single piece of rectangular tubing, however, in all cases, the inside height and width of collar 32 must correspond to the outside height and width of the first end boom 20, and must be sized to allow the first end boom 20 to slideably fit within collar 32. Lower cap piece 36b is welded to the edges 33 of vertical plates 30, thereby attaching collar 32 to end piece 12. Four reinforcing ribs 37 are attached to vertical plates 30 and first kingpin plate 28 to reinforce the end piece 12.

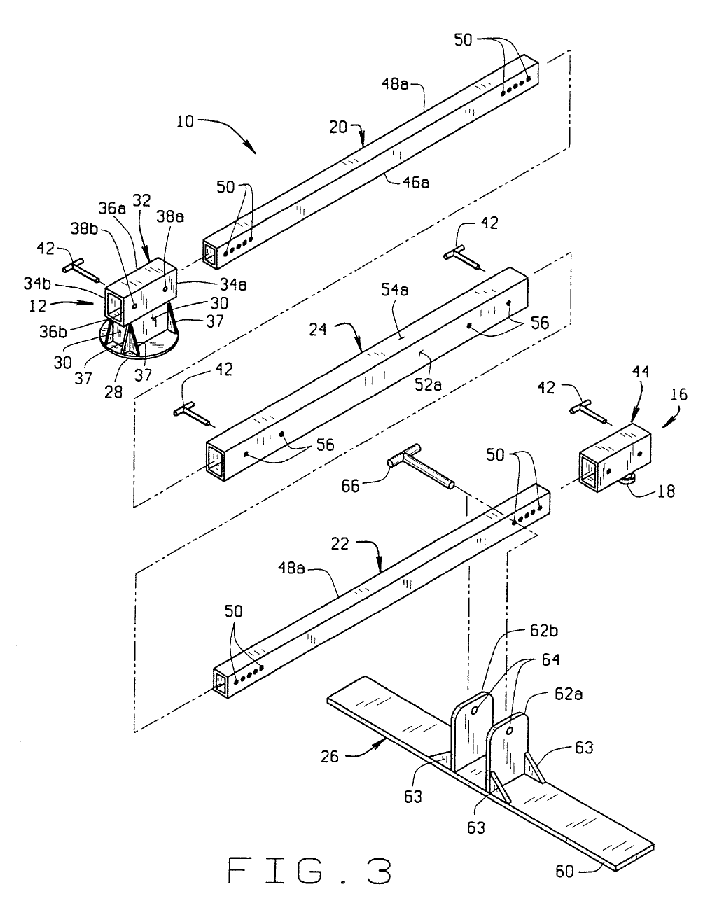

The first end piece 12 includes two locking pin openings 38a and 38b having a distance A between the center lines of the locking pin openings. Locking pin openings 38a and 38b are located within the first vertical side wall plate 34a and second vertical side wall plate 34b such that the locking pin openings in the first vertical side wall plate 34a are axially aligned with the locking pin openings in the second vertical side wall plate 34b. The locking pin openings are located along the horizontal center line of first vertical side wall plate 34a and the second vertical side wall plate 34b. The locking pin openings 38a and 38b are sized to provide a clearance fit for locking pins 42 (FIG. 3).

A second end piece 16 shown in FIG. 5A and FIG. 5B comprises a collar 44 which is rectangular in cross-section and is formed by a first vertical side wall plate 41a, a second vertical side wall plate 41b, an upper cap piece 43a, and a lower cap piece 43b. Alternatively, collar 44 may be manufactured from a single piece of rectangular tubing. The inside height and width of collar 44 correspond to the outside height and width of the second end boom 22 and are sized to allow the second end boom to slideably fit within collar 44. The kingpin 18 is connected to, and depends from, lower cap piece 43b.

Two locking pin openings 40, also having a distance A between the center lines of the locking pin openings, are located within first vertical side wall plate 41a and second vertical side wall plate 42b such that the locking pin opening are positioned to be axially aligned. The locking pin openings are located along the horizontal center line of first vertical side wall plate 41a and the second vertical side wall plate 41b. The locking pin openings 40 are sized to provide a clearance fit for locking pins 42 (FIG. 3).

FIG. 6A and FIG. 6B depict the general configuration of first end boom 20. First end boom 20 is rectangular in cross-section and is formed by a first vertical side plate 46a, a second vertical side plate 46b, an upper cap piece 48a, and a lower cap piece 48b. Alternatively, end boom 20 may be manufactured from a single rectangular tube. The exterior rectangular dimensions of the first end boom 20 are sized to slideably fit within connecting boom 24. One group of five locking pin openings 50 is located near each end of first end boom 20 and each locking pin opening is positioned such that the locking pin openings in the first vertical side wall plate 46b are axially aligned with the locking pin openings in the second vertical side wall plate 46a. The distance between any locking pin opening 50 and its nearest locking pin opening in each end of the first end boom 20 is equal to dimension A of the first end piece 12 and the second end piece 16. The locking pin openings 50 are sized to provide a clearance fit for locking pins 42 (FIG. 3). Second end boom 22 is identical in all general respects to first end boom 20.

Connecting boom 24 is shown in FIG. 7A and FIG. 7B. Connecting boom 24 is also rectangular in cross-section and is formed by a first vertical side wall plate 52a, a second vertical side wall plate 52b, an upper cap piece 54a, and a lower cap piece 54b. Alternatively, connecting boom 24 may be manufactured from a single piece of rectangular tubing. One group of two locking pin openings 56 is located near each end of the connecting boom 20 and each locking pin opening is positioned such that the locking pin openings in the first vertical side wall plate 52a are axially aligned with the locking pin openings in the second vertical side wall plate 52b. The locking pin openings are located along the horizontal center line of first vertical side wall plate 52a and the second vertical side wall plate 52b. The distance between the locking pin openings 50 at each end of connecting boom 24 is equal to dimension A of the first end piece 12 and the second end piece 16. The locking pin openings 56 are sized to provide a clearance fit for locking pins 42 (FIG. 3).

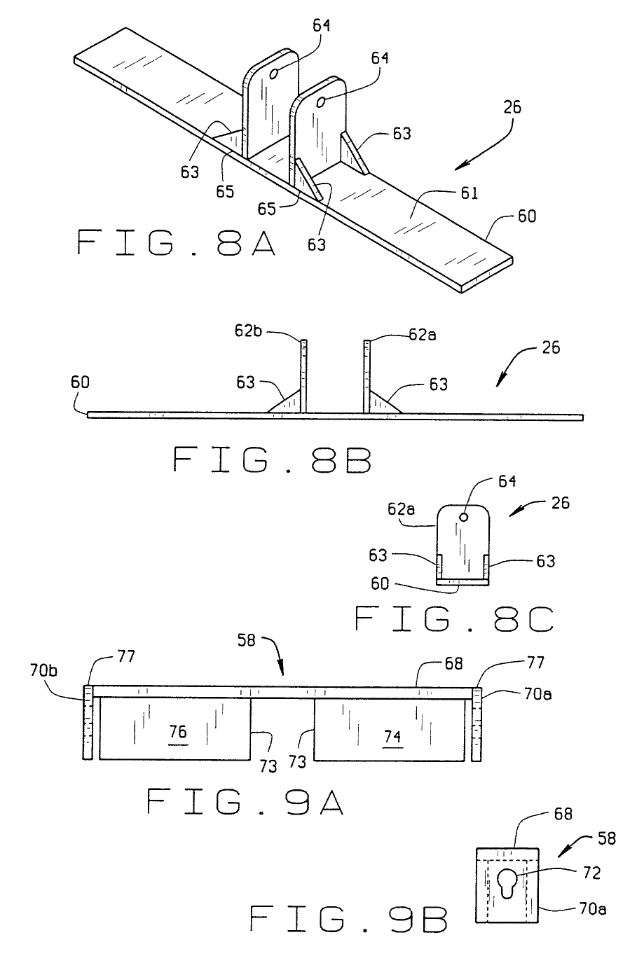

Straddle bar 26 is shown in FIGS. 8A-8C. The straddle bar 26 comprises a rectangular plate 60, a first vertical plate 62a, a second vertical plate 62b, and four reinforcing ribs 63. The first vertical plate 62a and the second vertical plate 62b are attached to the upper surface 61 of the rectangular plate 60 and are spaced apart such that there is a clearance fit to allow the second end boom 22 to slide between the vertical plates 62a and 62b. The center of the space between vertical plates 62a and 62b is centrally located on the length of rectangular plate 60. A reinforcing rib 63 is positioned where vertical plates 62a and 62b intersect with the upper surface 61 of rectangular plate 60, and are placed at the outer corner edges 65 of the vertical plates and the rectangular plate.

Each vertical plate 62a and 62b includes a locking pin opening 64. Each locking pin opening 64 is located on the vertical centerline of each vertical plate 62a and 62b and is sized to provide a clearance fit for locking pin 66. Each locking pin opening 64 is positioned such that the locking pin opening in the first vertical side plate 62a is axially aligned with the locking pin opening in the second vertical side plate 62b. Locking pin openings 64 are located to align with the locking pin openings 50 in second end boom 22.

In FIG. 9A and FIG. 9B, a cross member 58 is shown. The cross member 58 comprises a rectangular plate 68, first end plate 70a, second end plate 70b, two first face plates 74, and two second end plates 76. First end plate 70a and second end plate 70b are attached to each end of rectangular plate 68 such that edges 77 are flush with the upper surface 79 of rectangular plate 68. Two first face plates 74 and two second face plates 76 are attached to the bottom surface 81 of rectangular plate 68 and are positioned such that the distance between the end surfaces 83 of the face plates allow the second end boom 22 to fit between the end surfaces.

A keyhole is located in first end plate 70a and second end plate 70a. The keyhole 72 is positioned on the vertical centerline of the end plates 70a and 70b, and is configured to allow the insertion of the links of chain C (FIG. 1).

### Description of the Operation of the Invention

The truck towing apparatus 10 (FIG. 1) allows a truck T1 (FIG. 1) to tow another truck T2. However, before the truck towing apparatus 10 can be used, it must be properly installed onto the trucks T1 and T2.

To install the truck towing apparatus 10, proximal end 21 of first end boom 20 is slid into collar 32 of first end piece 12 until the locking pin openings 50 of the first end boom align with locking pin openings 38a and 38b of end piece 12. End boom 20 is secured to end piece 12 by insertion of two locking pins 42 into the two aligned locking pin openings. Proximal end 23 of end boom 22 is then slid into end piece 16 until the locking pin openings 50 of the second end boom align with the locking pin openings 40 in the second end piece. Two more locking pins 42 are inserted into the aligned locking pin openings.

If truck T2 has a fifth wheel F2, the assembly consisting of end boom 22 and end piece 16 is attached to truck T2 by inserting the kingpin 18 of end piece 16 into the fifth wheel F2 of truck T2, and then engaging and locking the kingpin into the fifth wheel.

If truck T2 does not have a fifth wheel, second end piece 16 is not used. Instead, straddle bar 26 is attached to truck T2 by placing the straddle bar onto a cross member of the chassis of truck T2 and then attaching the straddle bar to the truck cross member of the truck chassis by means of bolts and nuts. After attachment of straddle bar 58 to the truck chassis, proximal end 23 of end boom 22 is slid into position between vertical plates 62a and 62b of the straddle bar until the locking pin openings 50 of the second end boom align with the locking pin openings 64 of the straddle bar.

After end boom 22 is attached to truck T2, connecting boom 24 is slid onto distal end 27 of end boom 22 until the locking pin openings 56 of the connecting boom align with the locking pin openings 50 of the second end boom. Two locking pins 42 are inserted into the aligned locking pin openings to attach connecting boom 24 to end boom 22. Distal end 25 of first end boom 20 is then inserted into connecting boom 24 until the locking pin openings 50 of the first end boom align with the locking pin openings 56 of connecting boom 24. Two locking pins 42 are inserted into the aligned locking pin openings.

First end piece 12 is slid onto proximal end 21 of first end boom 20 until the locking pin openings 38a and 38b of the first end piece align with the locking pin openings 50 of the first end boom. Two locking pins 42 are inserted into the aligned locking pin openings.

Cross member 58 is then placed into position on second end boom 22 and the cross member is adjusted along the length of the second end boom until the cross member is over a truck frame chassis member capable of supporting the rear end of truck T2. Chain C is wrapped around the truck frame chassis member and the chain is passed through the keyhole openings 72 of cross member 58.

The rear end of truck T2 is then raised by either backing the rear end of truck T2 onto wheel ramps or by lifting the rear end of truck T2 with a hoist. The rear end of truck T2 is lifted until kingpin 14 of front end piece 12 is engaged with fifth wheel F1 of truck T1. While wheel ramps and hoists are suggested for elevating the rear end of truck T2, these are offered as examples only and any other elevating means may be used to lift the rear end of the truck. The lifting elevating means is not an integral part of the present invention.

Truck T1 is slowly backed toward front end piece 12 until kingpin 14 engages and is locked into fifth wheel F1 of truck T1. After the kingpin 14 is engaged and locked into fifth wheel F1, either the chain hoist is removed or the attached trucks T1 and T2 are backed off of the wheel ramps. Upon connection of all electrical wiring and brake lines from truck T1 to truck T2, truck T2 is ready for towing to another location by truck T1. Upon arriving at its destination, the truck towing apparatus is removed from trucks T1 and T2 by reversing the above installation procedure.

In view of the foregoing, it will be seen that the several objects of the invention are achieved and other advantageous results are obtained.

As various changes could be made in the above constructions without departing from the scope of the invention, it is intended that all matter contained in the above description or shown in the accompanying drawings shall be interpreted as illustrative and not in a limiting sense.

What I claim is:

1. A truck towing apparatus for connecting a towing truck to a truck with a fifth wheel plate to be towed, comprising:
a first end piece attachable to a first fifth wheel of a towing truck;
a second end piece attachable to a second fifth wheel of a truck to be towed;
a first end boom attachable to the first end piece and a second end boom attachable to the second end piece, each of said first end boom and second end boom having a proximal end and a distal end;
a connecting boom to which the distal end of the first end boom and the distal end of the second end boom are attached;
a cross member for supporting the truck to be towed from the second end boom; and,
a chain for connecting the cross member to a truck frame chassis member of the truck to be towed.

2. The apparatus of claim 1 wherein each of the first end piece and the second end piece includes a collar into which the proximal end of one of the first end boom and the proximal end of the second end boom is received.

3. The apparatus of claim 2 wherein each of the first end piece and the second end piece have a kingpin for respectively attaching the first end piece to the fifth wheel of the towing truck and the second end piece to the second fifth wheel of he truck to be towed.

4. The apparatus of claim 3 wherein the collar of the first end piece and the collar of the second end piece include at least one locking pin opening therein and the proximal and distal ends of the first end boom and the second end boom have at least one corresponding locking pin opening therein, and further including a first set of locking pins insertable through the at least one locking pin opening after the at least one corresponding locking pin opening in the first end boom is aligned with the at least one locking pin opening in the collar of the first end piece, and the at least one corresponding locking pin opening in the second end boom is aligned with the at least one locking pin opening in the collar of the second end piece.

5. The apparatus of claim 4 wherein the first end boom, second end boom, and connecting boom are each rectangular in cross-section with the connecting boom having an opening at each end sized to allow a distal end of one of the first end boom and second end booms to be inserted.

6. The apparatus of claim 5 wherein the connecting boom has a set of locking pin openings therein sized and located to be alignable with the at least one corresponding locking pin opening in the distal end of the first end boom and the distal end of the second end boom, and further including a second set of locking pins insertable through the aligned locking pin openings after the at least one corresponding locking pin opening in the connecting boom are aligned with the at least one locking pin openings at the distal end of the first end boom and at least one locking pin opening in the distal end of the second end boom.

7. The apparatus of claim 6 wherein the cross member further includes a top rectangular plate whose length is such that the plate extends beyond the opposite sides of the connecting boom, and further including a first end plate and a second end plate which are respectively attached to and depending from opposite outer ends of the plate, the respective end plates each having an opening therein.

8. The apparatus of claim 7 wherein the cross member further includes a first face plate, and a second face plate attached to a bottom of the top rectangular plate and extending inwardly from one of the respective endplates, each of the first and second face plates having inner ends, the length of the first and second face plates being such that there is a space between their respective inner ends corresponding to the width of the connecting boom for the cross member to straddle the connecting boom when in place.

9. A truck towing apparatus for connecting a towing truck to a truck without a fifth wheel plate to be towed, comprising:
a first end piece attachable to a first fifth wheel of a towing truck;
a second end piece;
a first end boom attachable to the first end piece and a second end boom attachable to the second end piece, each of said first end boom and second end boom having a proximal end and a distal end;
a connecting boom to which the distal end of the first end boom and the distal end of the second end boom are attached, the connecting boom having a top, a bottom, a width and two opposite sides;
a cross member comprising a top rectangular plate having a length, a bottom, and two outer ends, the length of the top rectangular plate being such that it extends beyond the two opposite sides of the connecting boom, a first end plate and a second end plate respectively attached to and depending from each of the two outer ends of the top rectangular plate, the first end plate and the second end plate each having a generally mushroomed shape opening; and,
a first chain for connecting the cross member to a truck frame chassis member of the truck to be towed;
a straddle bar having a first vertical plate and a second vertical plate attached to a rectangular plate, the spacing between the first vertical plate and the second vertical plate being slightly greater than the width of the connecting boom, each of the first and second vertical plates having at least one locking pin opening formed therein and located to correspond and align with locking pin openings in the proximal end of the second end boom, and further including a locking pin insertable through the aligned locking pin openings; and,
a second chain for attaching the straddle bar to the rear end of the truck to be towed after the truck to be towed is elevated to maintain the rear end of the truck to be towed in its raised position.

10. The apparatus of claim 9 wherein the first end piece includes a collar into which the distal end of the first end boom is received.

11. The apparatus of claim 10 wherein the first end piece has a kingpin for attaching the first end piece to the fifth wheel of the towing truck.

12. The apparatus of claim 9 wherein the collar of the first end piece include at least one locking pin opening therein and the respective proximal and distal ends of the first end boom and the second end boom have at least one corresponding locking pin opening therein, and further including a first set of locking pins insertable through the at least one locking pin opening after the at least one corresponding locking pin opening in the first end boom is aligned with the at least one locking pin opening in the collar of the first end piece, and the at least one corresponding locking pin opening in the second end boom is aligned with the at least one locking pin opening first and second vertical plates of the straddle bar.

13. The apparatus of claim 12 wherein the first end boom and the second end boom are rectangular in cross-section and the connecting boom includes an internal longitudinal opening sized to allow the distal end of the first end boom and the distal end of the second end boom to be inserted.

14. The apparatus of claim 13 wherein the connecting boom has a set of locking pin openings therein sized and located to be alignable with the at least one corresponding locking pin opening in the distal end of the first end boom and the distal end of the second end boom, and further including a second set of locking pins insertable through the aligned locking pin openings after the at least one corresponding locking pin opening in the connecting boom are aligned with the at least one locking pin openings at the distal end of the first end boom and at least one locking pin opening in the distal end of the second end boom.

15. The apparatus of claim 14 wherein the cross member further includes a first face plate and a second face plate attached to the bottom of the top rectangular plate and extending inwardly from one of the respective endplates, each of the first and second face plates having inner ends, the length of the first and second face plates being such that there is a space between their respective inner ends corresponding to the width of the connecting boom for the cross member to straddle the connecting boom when in place.

16. A truck towing apparatus for connecting a towing truck to a truck with a fifth wheel plate to be towed, comprising:
a first end piece attachable to a first fifth wheel of a towing truck, the first end piece having a first collar, a kingpin box, and a first end boom,
the first collar being rectangular shaped and having two locking pin openings through the collar, the two locking pin openings being parallel and spaced apart a predetermined distance,
the kingpin box including four vertical plates, a kingpin plate, four reinforcing ribs, and a first kingpin depending from the kingpin plate, the kingpin axis being perpendicular to the axis of the two locking pin openings of the first collar,
the first end boom having a proximal and a distal end, and being rectangular and sized to slide within the rectangular opening of the first collar, the first end boom also having a first group of five locking pin openings in the proximal end of the first end boom and a second group of five locking pin openings in the distal end of the first end boom, the first group of five locking pin openings of the first end boom being of identical size, and parallel to, the second group of five locking pin openings of the first end boom, the first group of five locking pin openings of the first boom and the second group of five locking pin openings of the first end boom having a predetermined distance apart between each of the five locking pin openings in each group, with each locking pin opening being the same size as the two locking pin openings in the first collar, the first group of five locking pin openings being located in the first end boom so as to align with the two locking pin openings in the first collar when the first end boom is slid into the first collar;
a second end piece,
the second end piece having a second collar and a second end boom,
the second collar being rectangular shaped having two locking pin openings the same size and shape of the second locking pin openings of the second end boom, the second end collar also having a second kingpin depending from the second collar, the axis of the kingpin being perpendicular to the axes of the two locking pin openings of the second collar, the second collar being rectangular shaped and having two locking pin openings through the collar, the two locking pin openings being parallel and spaced apart a predetermined distance,
the second end boom having a proximal end and a distal end, and being rectangular and sized to slide within the rectangular opening of the second collar, the second end boom also having a first group of five locking pin openings in the proximal end and a second group of five locking pin openings in the distal end, the first group of five locking pin openings of the second end boom being of identical size, and parallel to, the second group of five locking pin openings of the second end boom, the first group of five locking pin openings of the second boom and the second group of five locking pin openings of the second end boom having a predetermined distance apart between each of the five locking pin openings in each group, with each locking pin opening being the same size as the two locking pin openings in the second collar, the second group of five locking pin openings being located in the second end boom so as to align with the two locking pin openings in the first collar when the second end boom is slid into the second collar;
a connecting boom having a distal end and a proximal end, and being sized and shaped to slide over the distal end of the first end boom and the proximal end of the second end boom, the connecting boom also having a first group of two connecting boom locking pin openings being located at the distal end of the connecting boom, and a second group of two connecting boom locking pin openings located at the distal end of the connecting boom, the first group of two connecting boom locking pin openings being of identical size, and parallel to, the second group of two connecting boom locking pin openings, the first group of two connecting boom locking pin openings and the second group of two connecting boom locking pin openings having a predetermined distance apart between the two locking pin openings in each group, with each locking pin opening being the same size as the two locking pin openings in the second collar;
a cross member bar having a top rectangular plate, a first end plate, a second end plate, two first face plates, and two second face plates,
the top rectangular plate having a top surface, a bottom surface, a distal end, a proximal end, a leading edge, and a trailing edge,
the first end plate having a first front surface and a top edge, the first end plate having a generally mushroomed shape opening through the first front surface,
the second end plate having a second front surface and a top edge, the second end plate also having a generally mushroomed shaped opening through the second front surface,
the two first face plates having a front surface,
the two second face plates having a rear surface,
the two first face plates being attached to the top rectangular plate with the front surface of the two first face plates perpendicular to the bottom surface of the top rectangular plate and flush with the leading edge of the top rectangular plate, the two first end plate being attached to the distal end of the top rectangular plate with the top edge of the first end plate being flush with the top surface of the top rectangular plate, the two first face plates being spaced apart to create an opening sized to allow the cross member to slide over the second end boom such that the bottom surface of the top rectangular plate rests on the second end boom,
the two second face plates being attached to the top rectangular plate with the front surface of the two second face plates perpendicular to the bottom surface of the top rectangular plate, the second end plate being attached to the proximal end of the top rectangular plate with the top edge of the second end plate being flush with the top surface of the rectangular plate and flush with the trailing edge of the top rectangular plate, the two second face plates being spaced apart to create an opening sized to allow the cross member to slide over the second end boom such that the bottom surface of the top rectangular plate rests on the second end boom,
the first end plate and the second end plate being attached to the top rectangular plate such that the generally mushroomed shaped opening of the first end plate are axially alignment with the generally mushroomed opening of the second end plate; and,
a set of locking pins insertable through the locking pin openings of the first end boom, the second end boom, and the connecting boom.

17. A truck towing apparatus for connecting a towing truck to a truck without a fifth wheel plate to be towed, comprising:
a first end piece attachable to a first fifth wheel of a towing truck, the first end piece having a first collar, a kingpin box, and a first end boom,
the first collar being rectangular shaped and having two locking pin openings through the first collar, the two locking pin openings being parallel and spaced apart a predetermined distance,
the kingpin box including four vertical plates, a kingpin plate, four reinforcing ribs, and a first kingpin depending from the kingpin plate, the kingpin axis being perpendicular to the axis of the two locking pin openings of the first collar,
the first end boom having a proximal and a distal end, and being rectangular and sized to slide within the rectangular opening of the first collar, the first end boom also having a first group of five locking pin openings in the proximal end of the first end boom and a second group of five locking pin openings in the distal end of the first end boom, the first group of five locking pin openings of the first end boom being of identical size, and parallel to, the second group of five locking pin openings of the first end boom, the first group of five locking pin openings of the first boom and the second group of five locking pin openings of the first end boom having a predetermined distance apart between each of the five locking pin openings in each group, with each locking pin opening being the same size as the two locking pin openings in the first collar, the first group of five locking pin openings being located in the first end boom so as to align with the two locking pin openings of the first collar when the first end boom is slid into the first collar;
a second end piece,
the second end piece having a second end boom and a straddle bar,
the second end boom having a proximal end and a distal end and being rectangular shaped and sized to match the shape and size of the first end boom, the second end boom also having a first group of five locking pin openings in the proximal end and a second group of five locking pin openings in the distal end, the first group of five locking pin openings of the second end boom being of identical size, and parallel to, the second group of five locking pin openings of the second end boom, the first group of five locking pin openings of the second boom and the second group of five locking pin openings of the second end boom having a predetermined distance apart between each of the five locking pin openings in each group, with each locking pin opening being the same size as the two locking pin openings in the first collar,
the straddle bar having a rectangular plate, a first vertical plate, a second vertical plate, and two reinforcing ribs,
the rectangular plate having a top surface, a front edge and a rear edge,
the first vertical plate and the second vertical plate being attached to the top surface of the rectangular plate and spaced part to create a pass through opening sized and shaped to allow the second end boom to slide between the first vertical plate and the second vertical plate, the pass through opening being centered on the top surface of the rectangular plate,
the first vertical plate and the second vertical plate each having a locking pin opening the same size and shape of the second group of five locking pin openings in the second end boom, the locking pin openings of the first vertical plate and the second vertical plate being sized and located in the first vertical plate and second vertical plate so as to individually align with any one of the five locking pin openings in the second end boom as the second end boom is slid between the first vertical plate and the second vertical plate;
a connecting boom having a distal end and a proximal end, and being sized and shaped to slide over the distal end of the first end boom and the proximal end of the second end boom,
the connecting boom having a first group of two connecting boom locking pin openings being located at the distal end of the connecting boom, and a second group of two connecting boom locking pin openings located at the distal end of the connecting boom,
the first group of two connecting boom locking pin openings being of identical size, and parallel to, the second group of two connecting boom locking pin openings,
the first group of two connecting boom locking pin openings and the second group of two connecting boom locking pin openings having a predetermined distance apart between the two locking pin openings in each group, with each locking pin opening being the same size as the two locking pin openings in the second collar;
a cross member bar having a top rectangular plate, a first end plate, a second end plate, two first face plates, and two second face plates,
the top rectangular plate having a top surface, a bottom surface, a distal end, a proximal end, a leading edge, and a trailing edge,
the first end plate having a first front surface and a top edge, the first end plate having a generally mushroomed shape opening through the first front surface,
the second end plate having a second front surface and a top edge, the second end plate also having a generally mushroomed shaped opening through the second front surface,
the two first face plates having a front surface,
the two second face plates having a rear surface,
the two first face plates being attached to the top rectangular plate with the front surface of the two first face plates perpendicular to the bottom surface of the top rectangular plate and flush with the leading edge of the top rectangular plate, the two first end plate being attached to the distal end of the top rectangular plate with the top edge of the first end plate being flush with the top surface of the top rectangular plate, the two first face plates being spaced apart to create an opening sized to allow the cross member to slide over the second end boom such that the bottom surface of the top rectangular plate rests on the second end boom,
the two second face plates being attached to the top rectangular plate with the front surface of the two second face plates perpendicular to the bottom surface of the top rectangular plate, the second end plate being attached to the proximal end of the top rectangular plate with the top edge of the second end plate being flush with the top surface of the rectangular plate and flush with the trailing edge of the top rectangular plate, the two second face plates being spaced apart to create an opening sized to allow the cross member to slide over the second end boom such that the bottom surface of the top rectangular plate rests on the second end boom,
the first end plate and the second end plate being attached to the top rectangular plate such that the generally mushroomed shaped opening of the first end plate are axially alignment with the generally mushroomed opening of the second end plate; and,
a set of locking pins insertable through the locking pin openings of the first end boom, the second end boom, and the connecting boom.

18. A method of connecting a towing truck to a truck to be towed so the towing truck can tow the towed truck from one location to another comprising:
attaching a first end piece to a first fifth wheel of a towing truck;
attaching a second end piece to a second fifth wheel of a truck to be towed;
attaching a first end boom to the first end piece and a second end boom the second end piece, each of the first and second end booms having a proximal end;
attaching the proximal end of the first end boom to the first end piece;
attaching the proximal end of the second end boom to the second end piece;
attaching the distal end of each of the first and second end booms to a connecting boom;
straddling an end boom with a cross member;
elevating the rear end of the truck to be towed off the ground; and,
attaching the rear end of the truck to be towed to the cross member with a chain to maintain the rear end of the towed truck in its raised position.

19. A method of connecting a towing truck to a truck to be towed, the truck to be towed not having a fifth wheel, so that the towing truck can tow the truck to be towed from one location to another comprising:
attaching an end piece to a first fifth wheel of a towing truck;
attaching a straddle bar to a frame member of a truck to be towed;
attaching a first end boom having a proximal and a distal end to the end piece by attaching the proximal end to the end piece;
attaching a second end boom having a proximal and a distal end the straddle bar by attaching the proximal end of the second end boom to the straddle bar;
attaching the distal end of each of the first and second end booms to a connecting boom;
straddling an end boom with a cross member;
attaching a cross member to the second end boom;
elevating the rear end of the truck to be towed off the ground; and,
attaching the rear end of the truck to be towed to the cross member with a chain to maintain the rear end of the towed truck in its raised position.
